(19) United States
(12) Patent Application Publication
(10) Pub. No.: US 2015/0139503 A1
(43) Pub. Date: May 21, 2015

(54) MOTION PARAMETER ESTIMATION

(71) Applicant: KONINKLIJKE PHILIPS N.V., EINDHOVEN (NL)

(72) Inventors: Sven Kabus, Hamburg (DE); Cristian Lorenz, Hamburg (DE); Tobias Klinder, Uelzen (DE); Jens Von Berg, Hamburg (DE)

(21) Appl. No.: 14/405,792

(22) PCT Filed: Jun. 17, 2013
(86) PCT No.: PCT/IB2013/054932

§ 371 Date: Dec. 5, 2014

Related U.S. Application Data
(60) Provisional application No. 61/664,874, filed on Jun. 27, 2012.

(51) Int. Cl. G06T 7/20; G06T 7/00

(52) U.S. Cl. CPC G06T 7/2046; G06T 7/0016; G06T 2207/10076; G06T 2207/30048; G06T 2207/30061
USPC 382/107

(57) ABSTRACT

An object motion parameter determiner (122) includes a deformation vector field determiner (210) that determines deformation vector fields for a 4D image set, which includes three or more images corresponding to three or more different motion phases of motion of a moving object. The object motion parameter determiner further includes a volume curve determiner (212) that generates a volume curve for the voxel based on the deformation vector fields. The object motion parameter determiner further includes a model fitter (214) that fits a predetermined motion model to the volume curve. The object motion parameter determiner further includes a parameter determiner (218) that estimates at least one object motion parameter based on the fitted model.

The following generally relates to estimating motion parameters of a moving object, and is described with particular application to computed tomography (CT). However, the following is also amenable to other imaging modalities.

Lung ventilation is a main indicator for the functioning of the respiratory system due to the fact that ventilation is linked to the change in lung volume. In particular, assessing ventilation on a local or regional level becomes increasingly important for diagnosis, e.g., for early detection of diseases, or for therapy planning, e.g., for functional avoidance in lung cancer radiotherapy.

Nuclear imaging such as single photon emission computed tomography (SPECT) or positron emission tomography (PET) are the current standard for direct functional assessment of lung ventilation, with SPECT ventilation/perfusion (SPECT V/Q) being the “gold” standard. Unfortunately, SPECT and PET suffer from low spatial resolution, high cost, long scan time and/or low accessibility.

Current image registration approaches make it possible to assess regional volume change (essentially ventilation) of the lungs on the basis of breathing gated 4D CT imaging. This is especially of interest for radiation therapy planning, where it is important to identify well-functioning lung regions, which can then be spared from radiation. The basic idea is to estimate deformation fields from a selected reference phase to all other phases which can then be analyzed to obtain the voxel-wise volume change over the respiratory cycle.

4D CT has been adopted by more and more radiation therapy centers as a standard imaging modality to assess tumor motion. Acquisitions are often taken again before each radiation fraction. A 4D CT based lung ventilation measurement could, therefore, be much easier integrated in the current radiation therapy planning workflow than the use of an additional modality such as SPECT. Generally, a breathing gated 4D CT acquisition typically consists of ten 3D CT images corresponding to ten phase points in the breathing cycle.

In order to estimate local volume change, the 3D images corresponding to only two phases, the max-exhale phase and the max-inhale phase, of the lungs are selected and registered using non-rigid registration. Local volume change information can be extracted from the registered images in two ways, i) based on intensity differences, or ii) based on local properties of the deformation field. However, the estimation can be affected by multiple sources of error, such as, for example, imaging artifacts, binning artifacts or image noise.

Imaging or binning artifacts can be spread over many slices, leading to non-optimal input data for the registration and thus may significantly affect the local volume change estimation. Examples of such artifacts include duplicate diaphragm contours or missing structures in one or both data sets to be registered. Unfortunately, imaging or binning artifacts are very common in dynamic acquisitions as diseased patients have typically have problems in breathing reproducibly.

Furthermore, the max-inhale and max-exhale phase may vary locally, leading to a regional underestimation of ventilation amplitude. Moreover, by focusing only on two phases of the breathing or inspecting each phase separately, the dynamics of the respiratory system are usually not considered. Estimating local volume changes with respect to other tissue of interest (e.g., cardiac, muscle, etc.) and/or moving non-anatomical objects may face similar obstacles.

In view of the foregoing, there is an unresolved need for other approaches for estimating local volume change.

Aspects described herein address the above-referenced problems and others.

In one aspect, an object motion parameter determiner includes a deformation vector field determiner that determines deformation vector fields for a 4D image set, which includes three or more images corresponding to three or more different motion phases of motion of a moving object. The object motion parameter determiner further includes a volume curve generator that generates a volume curve for a voxel based on the deformation vector fields. The object motion parameter determiner further includes a model fitter that fits a predetermined motion model to the volume curve. The object motion parameter determiner further includes a parameter determiner that estimates at least one object motion parameter based on the fitted model.

In another aspect, a system includes determining deformation vector fields for a 4D image set, which includes three or more images corresponding to three or more different motion phases of motion of a moving object. The system further includes generating a volume curve for a voxel based on the deformation vector fields. The system further includes fitting a predetermined motion model to the volume curve. The system further includes estimating at least one object motion parameter based on the fitted model and generating a signal indicative thereof.

In another aspect, a computer readable storage medium is encoded with computer readable instructions. The instructions, when executed by a processor, cause the processor to: determine at least one of a motion cycle amplitude or phase based at least three images corresponding to different motion phases and on a voxel-wise correspondence on the motion cycle.

The invention may take form in various components and arrangements of components, and in various steps and arrangements of steps. The drawings are only for purposes of illustrating the preferred embodiments and are not to be construed as limiting the invention.

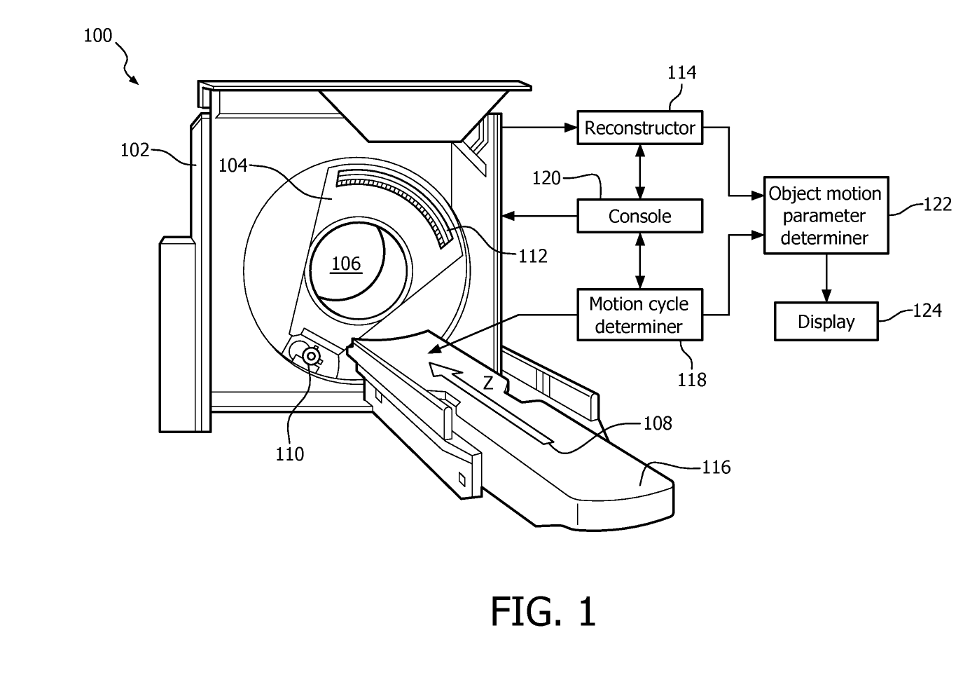

FIG. 1 schematically illustrates an imaging system in connection with an object motion parameter determiner.

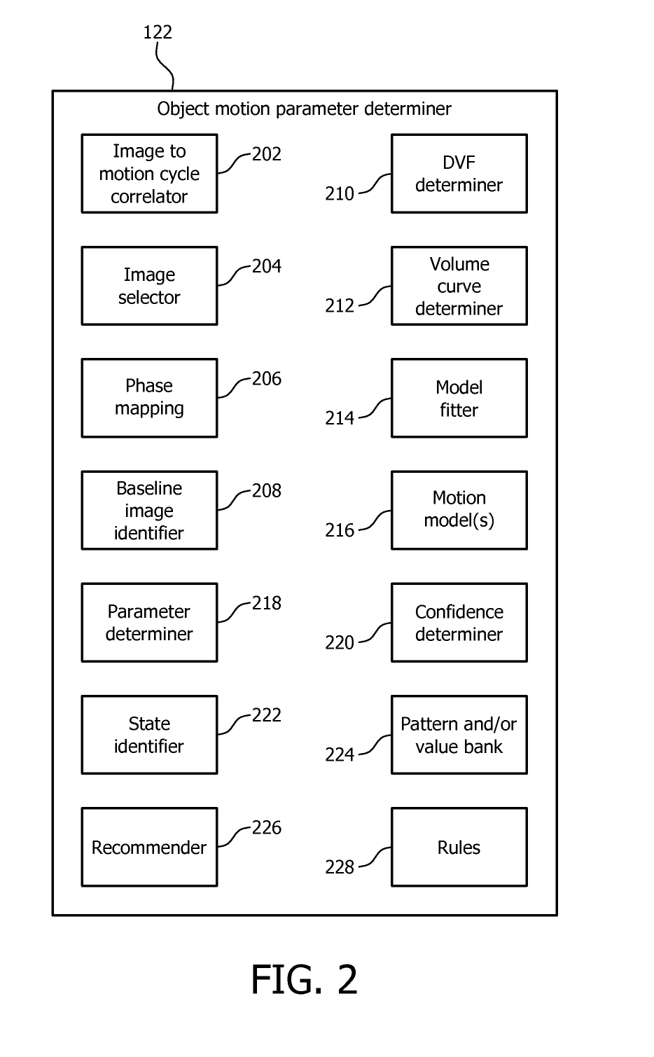

FIG. 2 illustrates an example of the object motion parameter determiner.

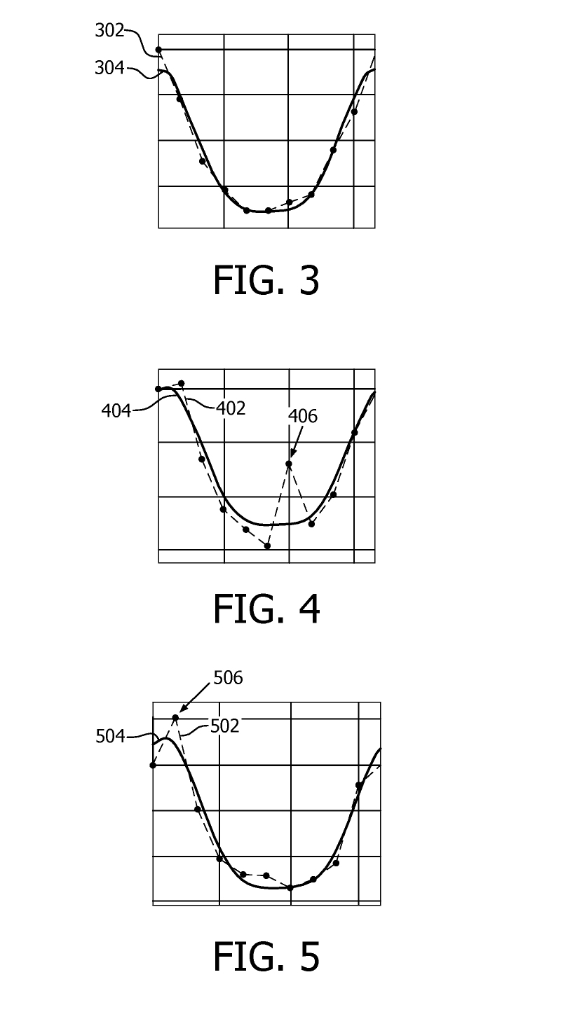

FIGS. 3, 4 and 5 illustrate examples of motion models fitted to measured motion trajectories.

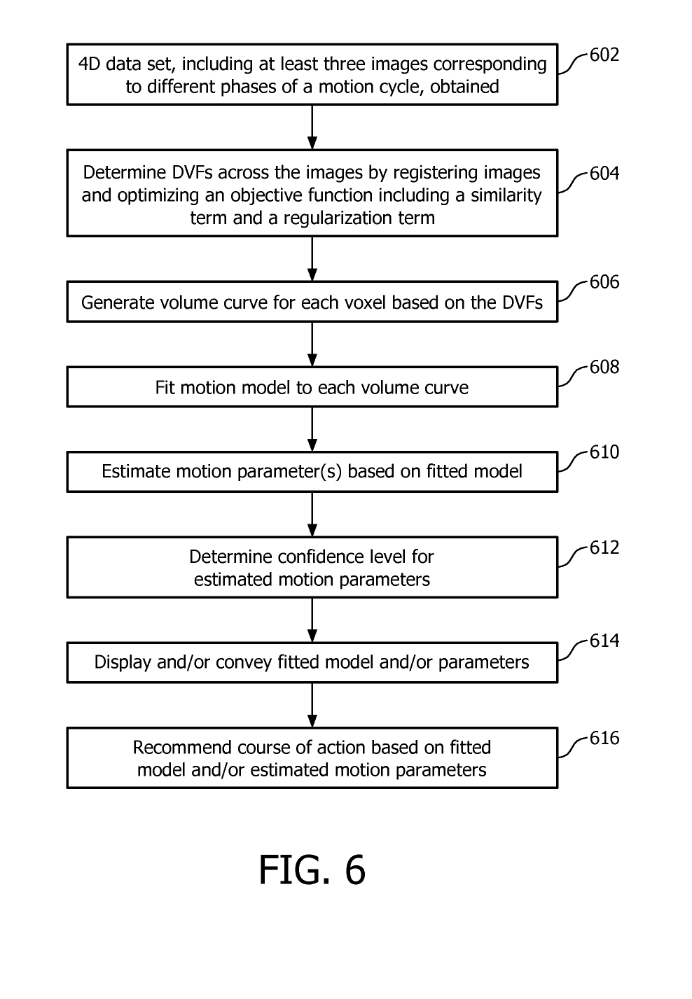

FIG. 6 illustrates an example method.

The following describes an approach to estimate motion parameters (e.g., amplitude, phase, phase shift, stiffness, etc.) of a moving object based on a 4D image set of the object. As utilized herein, a 4D image set includes 3D images of the moving object over the motion cycle of the moving object, which includes a full expansion phase, a full contraction phase, one or more phases between the full expansion and full contraction phases, and one or more phases between the full contraction and full expansion phases

By way of example, the respiratory motion cycle includes a full inhalation phase, a full exhalation phase, and phases there between. The cardiac motion cycle includes a maximum expansion phase, a maximum contraction phase and phases there between. Muscle, in general, includes fibers that move through a maximum contraction phase, a relaxation phase, and phases there between. Generally, the motion cycle can be associated with any tissue or non-anatomical structure that moves through a cycle of full expansion, to full contraction, and back to full expansion, one or more times.

As described in greater detail below, in one non-limiting instance, the motion parameters are estimated by processing a 4D image set that includes at least three 3D volumetric images, each representing a different phase of the motion cycle, to determine volume curves for each voxel across the three or more images (resulting in a 3D set of curves), fitting a predetermined motion model to each volume curve, and determining the function parameters based on the fitted models.

Suitable imaging modalities include modalities that can acquire a 4D image set such as, but are not limited to, CT and MR. For sake of brevity, the following is described in connection with CT. Initially referring to FIG. 1, an imaging system 100 such as a CT scanner is schematically illustrated. The imaging system 100 includes a generally stationary gantry 102 and a rotating gantry 104, which is rotatably supported by the stationary gantry 102 and rotates around an examination region 106 about a z-axis 108.

A radiation source 110, such as an x-ray tube, is rotatably supported by the rotating gantry 104, rotates with the rotating gantry 104, and emits radiation that traverses the examination region 106. A radiation sensitive detector array 112 subtends an angular arc opposite the radiation source 110 across the examination region 106. The radiation sensitive detector array 112 detects radiation traversing the examination region 106 and generates projection data indicative thereof for each detected photon.

A reconstructor 114 reconstructs the projection data, generating volumetric image data indicative of a scanned portion of a subject or object located in the imaging region 106. This includes reconstructing data acquired during 4D acquisitions, which include 3D acquisitions of a moving object acquired over time over one or more motion cycles of the moving object. A subject support 116, such as a couch, supports an object or subject in the examination region 106.

A motion cycle determiner 118 determines a motion cycle of the moving object. For respiratory motion, the motion cycle determiner 118 may include a respiratory belt, external markers positioned on the moving object, etc. For cardiac applications, the motion cycle determiner 118 may include an electrocardiograph (ECG). For muscle applications, the motion cycle determiner 118 may include a pressure sensor. The motion cycle is determined concurrently with data acquisition in time.

A general-purpose computing system or computer serves as an operator console 120. The console 120 includes a human readable output device such as a monitor and an input device such as a keyboard, mouse, etc. Software resident on the console 120 allows the operator to interact with and/or operate the scanner 100 via a graphical user interface (GUI) or otherwise. For example, the console 120 allows the operator to select an imaging protocol such as a motion gated (e.g., respiratory, cardiac, muscle, etc.) 4D CT acquisition.

An object motion parameter determiner 122 processes 4D data sets such as the 4D image set acquired by the imaging system 100 and/or other imaging system. As described in greater detail below, in one instance, the object motion parameter determiner 122 determines a volume curve for each voxel across the images of the 4D image set, each image corresponding to a different phase of the motion cycle of the object, fits a predetermined motion model to each volume curve, determines the motion parameters of the moving object based on the fitted model (which represents a voxel-wise volume change over the entire motion cycle that takes into the dynamics of the motion cycle), and generates a signal indicative thereof. The results can be visually presented via a display 124 and/or conveyed to one or more other devices.

The foregoing approach to determining the motion parameters of the moving object results is a more plausible estimate of the parameters relative to a configuration of the system 100 in which only two phases, such as the maximum expansion and the maximum expansion phases, of the motion cycle are considered since more phases and thus more information about the motion is employed. This approach also makes it possible to assess regional volume change and thus is well-suited for applications like radiation therapy planning where it is important to identify well-functioning lung regions which can then be spared from radiation. This will also allow 4D CT image set to be adopted by more and more radiation therapy centers since acquisitions are often made before each radiation fraction and the 4D CT image set can be integrated into the radiation therapy planning workflow.

It is to be appreciated that the object motion parameter determiner 122 can be implemented via a computing system, such as a computer, which includes one or more processors executing one or more computer readable instructions encoded, embed, stored, etc. on computer readable storage medium such as physical memory and/or other non-transitory memory. Additionally or alternatively, at least one of the computer readable instructions in can be carried by a signal, carrier wave and/or other transitory medium. The computing system also includes a human readable output device such as a monitor and an input device such as a keyboard, mouse, etc. As will be recognized by one of ordinary skill in the art, in another embodiment, one or more of the components (described below) of the object motion parameter determiner 122 can alternatively be implemented in different computing systems.

FIG. 2 illustrates an example of the object motion parameter determiner 122.

An image to motion cycle correlator 202 receives the 4D image set and the motion cycle signal and correlates the images of the 4D image set with the motion cycle. For example, the image to motion cycle correlator 202 can create a mapping that identifies, for any particular phase of the motion cycle, the image(s) of the 4D image set that was acquired during that particular phase, and/or for any particular image(s) of the 4D image set, the time point (and hence the motion phase) of the motion cycle at which the image was acquired.

An image selector 204 selects a group of images from the 4D image set to process. In one instance, the image selector 204 selects the entire set of images to process. In another instance, the image selector 204 selects a sub-set of the images, which includes at least three images corresponding to three different phases of the motion cycle. The image selector 204 may select the images based on user input, default or user specified settings (e.g., full expansion, full contraction, and one or more phases of interest there between), and/or other criteria.

By way of non-limiting example, in one instance the image selector 204 selects N (e.g., N=10) images that cover N different equally spaced phases of a motion cycle. For instance, where a motion cycle is delineated based on percentage with 0% being the first phase and 99% being the last phase before the motion cycle is repeated back at the 0% phase, the selected images may cover phases 0%, 10%, 20%, 30%, 40%, 50%, 60%, 70%, 80% and 90%. Other phases and/or other phase spacing, including non-equal spacing, are contemplated herein.

A phase mapping 206 provides a mapping between the percentage and the state of the contraction/expansion. For example, 0% may represent maximum expansion, maximum contraction, or some amount of expansion/contraction there between. However, for explanatory purposes, 0% represents the maximum expansion phase for this example. For instance, with respect to respiratory ventilation, 0% represents maximum inhalation, 60% represents maximum exhalation, 10-50% represent the transition from maximum inhalation to maximum exhalation, and 70-90% represent the transition from maximum exhalation to maximum inhalation.

A baseline image identifier 208 identifies one or more of the selected images as a baseline image. This can be achieved through an automated approach and/or with user interaction. In one instance, the 0% phase is identified as the baseline image. The below discussion is based on such an identification. However, a different phase and/or more than one phase can be selected. For example, every odd numbered (or even numbered) phase can be identified as a baseline image.

Where the input images are already correlated to the motion cycle and selected for processing, the image to motion cycle correlator 202, the image selector 204, the mapping 206, and the baseline image identifier 208 can be omitted.

A deformation vector field (DVF) determiner 210 determines a deformation vector field (DVF) between the selected baseline image and each of the other images in the selected image set. Where one phase is selected (e.g., the 0% phase), this includes determining DVFs between the 0% phase image and each of the other selected images. Thus, where the selected image set includes N images, the deformation vector field determiner 210 determines N−1 sets of DVFs (i.e., a DVF for each pair of images). In another instance, DVFs are determined between neighboring pairs of images (e.g., between images 1 and 2, images 3 and 4, and so on) and/or other approaches.

The deformation vector field determiner 210 can use various approaches to determine DVFs. For example, the illustrated deformation vector field determiner 210 determines DVFs using a non-rigid (elastic) registration algorithm. In another instance, the deformation vector field determiner 210 employs a rigid (affine) registration algorithm and/or other algorithm. A suitable algorithm determines DVFs by mapping the baseline image onto the other images, and thus establishing a voxel-wise correspondence over the whole motion cycle, and then minimizes an objective function that includes a similarity measure and a regularizing term.

An example of such an algorithm is described in Kabus et al., Fast elastic image registration, In: Proc. of MICCAI Workshop: Medical Image Analysis For The Clinic —A Grand Challenge, (2010) 81-89. Generally, the algorithm described in Kabus et al. assumes a reference (or fixed) image R(x) and a template (or moving) image T(x). It finds an affine transformation p as well as a deformation vector field (DVF) u: [symbol] ³→ [symbol] ³ such that the displaced template image Tᵤ(x):=T(φ(p; x)+u(x)) minimizes both a similarity measure D and a regularizing term S. Here, the mapping φ(p; x) describes the transformation of voxel position x under an affine transformation given by the vector p.

A suitable similarity measure D, using sum of squared differences, is shown in EQUATION 1:

$$D [ u ] := \frac{1}{2} {\int }_{Ω}^{ } {W ( x ) [ R ( x ) - {T}_{u} ( x ) ]}^{2} d x , \qquad EQUATION 1$$

where W(x) is a weight map which depends on methodological choices, image modality, and/or application, and can be fixed or variable for the whole image. Other similarity measures based on correlation, entropy, image derivatives etc. are possible as well. A suitable regularizing term S, based on the Navier-Lame equation, is shown in EQUATION 2:

$$S [ u ] := {\int }_{Ω}^{ } ( \frac{μ}{4} {\sum }_{i , j = 1}^{3} {( {\partial }_{{x}_{j}} {u}_{i} ( x ) + {\partial }_{{x}_{i}} {u}_{j} ( x ) )}^{2} + \frac{λ}{2} {( ∇ \cdot u ( x ) )}^{2} ) d x . \qquad EQUATION 2$$

Here, the parameters λ and μ (Navier-Lamé parameters) describe the modeled material properties. They can be fixed or variable over the entire image. Regularizing terms based on other derivatives of u are possible as well. By combining the similarity measure D and the regularizing term S, the registration is formulated as minimizing the joint functional

$$D [ u ] + S [ u ] {\to }^{u} u min .$$

Further functionals can be added to the joint functional, for example to incorporate constraints such as landmark positions or DVF-related properties. Based on calculus of variations the joint functional is reformulated as a system of non-linear partial differential equations as shown in EQUATION 3:

μΔu+(μ+λ)∇·∇u=∇Tᵤ(R−Tᵤ). EQUATION 3:

For discretizing EQUATION 3, finite differences in conjunction with Neumann boundary conditions can be used. The resulting system of linear equations consists of a sparse, symmetric and highly structured matrix arising from the regularizing term and a force vector corresponding to the similarity measure. The system of equations can then be linearized and iteratively solved by a conjugate gradient scheme. The iteration is stopped based on predetermined criteria such as if the update in u is below 0.05 mm for all positions indicating convergence and/or otherwise.

A volume curve determiner 212 determines a volume curve for each voxel based on the DVFs. In one instance, this is achieved by calculating the Jacobian matrix, consisting of first derivatives of the deformation field. By way of non-limiting example, with N=10 images representing phases 0% through 90% in increments of 10% with the baseline image representing the phase 0%, for each DVF u^{0%→i%}, i=10, 20, . . . , 90, the voxel-wise volume change is determined by calculating the Jacobian c(x)x):=det(∇u^{0%→i%}(x)) for each voxel x of the DVF. An alternative approach includes calculating intensity differences.

Generally, the Jacobian estimates how much the region around a voxel is contracting or expanding. A value of one (1) corresponds to volume preservation whereas a value smaller (or larger) than one (1) indicates local compression (or expansion). For each voxel x, a vector is constructed as V(x):=(1; V^{0%→10%}(x), V^{0%→20%}(x) . . . V^{0%→90%}(x)) describing the volume change over the motion cycle as a volume curve in the temporal domain. For N images and N−1 registrations, the volume curve determiner 212 determines a volume curve for each image voxel across the set of images, each volume curve including N−1 values.

A model fitter 214 fits one or more of predetermined motion models 216 to the volume curve V(x). For respiratory ventilation, an example of a suitable model is cos²ⁿ, which is a 1D model used to describe lung volume vol(t) over the respiratory cycle. Other respiratory models include, but are not limited to models based on unhealthy tissue, models based on healthy tissue, models based on prior knowledge of a particular patient and/or pathology, etc. For other tissue of interest (e.g., cardiac, muscle, etc.), models corresponding to the respective tissue are employed.

With the respiratory model, the relative volume change, with respect to a designated baseline phase (e.g., 0% phase, representing full inhalation), is given as vol(t)/vol(t_{0%}). Subtracting 1 from this renders EQUATION 4:

$$\frac{vol ( t )}{vol ( {t}_{0 \%} )} - 1 = \frac{vol ( t ) - vol ( {t}_{0 \%} )}{vol ( {t}_{0 \%} )} = : \frac{Δ vol ( t )}{vol ( {t}_{0 \%} )} . \qquad EQUATION 4$$

With the 0% phase is full inhalation, l representing the number of motion phases, o representing a phase offset, α representing a motion amplitude, and φ representing the time of full exhalation, the EQUATION 4 can be expressed as shown in EQUATION 5:

$${V}^{model} ( x , t ) = o + α {cos}^{2 n} ( \frac{π}{1} ( t - φ ) + \frac{π}{2} ) , \qquad EQUATION 5$$

which describes the ventilation at time t for a fixed spatial position x. A value for n can be set to place emphasis on a particular phase (e.g., exhalation, which is usually longer than the inhalation)). EQUATION 5 can be alternately formulated to include one or more other parameters (e.g., stiffness, etc.) and/or omit one or more of o, α or φ.

The model fitter 214 fits V^{model} to V using an optimization approach such as a least-squares optimization implemented by a Gauβ-Newton and/or other scheme. FIGS. 3, 4 and 5 illustrate examples of V^{model} fitted to V for a voxel where the x-axis represents motion phase and the y-axis represents amplitude. In FIG. 3, V^{model} 302 is fitted to a volume curve V 304, which behaves similar to the model; in FIG. 4, V^{model} 402 is fitted to a volume curve V 404 that includes an outlier 406, which would cause the amplitude to be underestimated, and in FIG. 5, V^{model} 502 is fitted to a volume curve V 504 that is phase shifted as indicated at 506 such that expansion is not fullest at the 0% phase.

Returning to FIG. 2, a parameter determiner 218 solves EQUATION 5 for o, α and φ. The parameter determiner 218 can visually display the determined parameters via the display 124 (FIG. 1). The parameter determiner 218 may also visually display V^{model} fitted to V and/or V, concurrently with or separate from the parameters. The parameter determiner 218 can also generate a signal including such information and convey the signal to one or more other devices, such as a computing system running a therapy planning application.

A confidence determiner 220 can determine a confidence level for the estimated parameters. For example, in one instance, the confidence determiner 220 determines a fit error based on V^{model} and V. For example, one non-limiting fit error can be calculated as the squared difference between V^{model} and V, weighted with an inverse of the amplitude, as shown in EQUATION 6:

$$E ( x ) := \frac{1}{max ( α ( x ) , ɛ )} {‖ {V}^{model} ( x , t ) - V ( t ) ‖}^{2} \qquad EQUATION 6$$

This error can be used as confidence level for the estimate. The confidence determiner 220 can visually present the error along with one or more V^{model} fitted to V and/or the parameters, and/or generate an error signal including the error and convey the error signal to one or more other devices.

An optional state identifier 222 compares the display V^{model} fitted to V and/or one or more of the parameters with patterns and/or values stored in a pattern and/or parameter bank 224 in which the stored patterns and/or values are known healthy and/or unhealthy states. If the state identifier 222 is able to match the fitted V^{model} and/or the determined parameters to one or more patterns and/or values in the bank 224, the state identifier 222 generates a notification signal including the match.

The notification can be visually displayed via the display 124, showing the matched fitted V^{model} and/or the determined parameters, and/or the corresponding health state. The notification can also be conveyed to one or more other devices. If the state identifier 222 is unable to match the fitted V^{model} and/or the determined parameters to one or more patterns and/or values in the bank 224, the notification indicates this, or, alternatively, no notification is generated.

An optional recommender 226, based on a match of the state identifier 222, can generate a recommendation signal, which includes a recommendation for a course of action based on the identified state. In this example, the recommender 226 utilizes a set of predetermined rules 228 to determine the recommendation. The recommender 226 can visually present the recommendation signal in a human readable format via the display 124 and/or convey the recommendation signal to another device(s).

FIG. 6 illustrates an example.

It is to be appreciated that the ordering of the acts is not limiting. As such, other orderings are contemplated herein. In addition, one or more acts may be omitted and/or one or more additional acts may be included.

At 602, a 4D image data set, including at least three volumetric images corresponding to at least three different motion phases of a motion cycle of an object, for the moving object is obtained.

At 604, DVFs are generated for each voxel across the at least three volumetric images by registering the at least three volumetric images are registered with a baseline(s) image and optimizing an objective function including a similarity term and a regularization term.

At 606, a volume curve is generated for each voxel based on the DVFs. As described herein, the volume curve can be generated by calculating either the Jacobian matrix or intensity differences, and the volume curve shows how much a region around a voxel is contracting or expanding.

At 608, a predetermined motion model is fitted to each volume curve.

At 610, one or more motion parameters are estimated based on the fitted model. Examples of such parameters include, but are not limited to motion amplitude, phase, phase shift, stiffness, etc.

At 612, optionally, a confidence level for the estimated one or more motion parameters is generated based on the fitted model and the volume curve.

At 614, one or more of the fitted model, the one or more parameters, or the confidence level is visually displayed and/or conveyed to another device.

At 616, optionally, the one or more of the fitted model and/or the one or more parameters can be mapped to a set of curves and/or parameters corresponding to known heath states of tissue and used to recommend a course of action based on the health.

The above may be implemented by way of computer readable instructions, encoded or embedded on computer readable storage medium, which, when executed by a computer processor(s), cause the processor(s) to carry out the described acts. Additionally or alternatively, at least one of the computer readable instructions is carried by a signal, carrier wave or other transitory medium.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. An object motion parameter determiner, comprising:
a deformation vector field determiner that determines deformation vector fields for a 4D image set, which includes three or more images corresponding to three or more different motion phases of motion of a moving object;
a volume curve determiner that generates a volume curve for a voxel based on the deformation vector fields;
a model fitter that fits a predetermined motion model to the volume curve; and
a parameter determiner that estimates at least one object motion parameter based on the fitted model.

2. The object motion parameter determiner of claim 1, wherein the deformation vector field determiner determines the deformation vector fields using a non-rigid registration.

3. The object motion parameter determiner of claim 2, wherein the non-rigid registration maps a phase of an image corresponding one of the three or more images to the different phases of the other images of the three or more images, thereby determining a voxel-wise correspondence on the motion cycle.

4. The object motion parameter determiner of claim 3, wherein the deformation vector field determiner determines the deformation vector fields by minimizing an objective function that includes a weighted similarity term and a regularizing term.

5. The object motion parameter determiner of claim 1, wherein the volume curve determines the volume curve by calculating a Jacobian matrix consisting of first derivatives of the deformation vector fields.

6. The object motion parameter determiner of claim 1, wherein the volume curve determiner determines the volume curve by calculating intensity differences of the deformation vector fields.

7. The object motion parameter determiner of claim 5, wherein the volume curve describes a volume change over the motion cycle as a function of time.

8. The object motion parameter determiner of claim 1, wherein the model is a curve represented by a cos²ⁿ function, wherein n corresponds to a phase of interest.

9. The object motion parameter determiner of claim 8, wherein the at least one object motion parameter includes at least one of a motion amplitude, a motion phase, a motion offset, or a time of a predetermined motion phase.

10. The object motion parameter determiner of claim 1, further comprising:
a confidence determiner that determines a confidence level of the estimate based on an error difference between the fitted model and the volume curve.

11. The object motion parameter determiner of claim 10, wherein the confidence level is determined based on a squared difference between the fitted model and the volume curve, weighted with an inverse of an amplitude of the motion cycle.

12. The object motion parameter determiner of claim 1, further comprising:
a state identifier that identifies a state of the object by comparing one or more of the fitted model or the at least one object motion parameter based on a bank of patterns and/or values corresponding to known healthy and unhealthy states.

13. The object motion parameter determiner of claim 12, further comprising:
a recommender that recommends a course of action for the object based on the determined state of the object.

14. The object motion parameter determiner of claim 1, further comprising:
a display that displays at least one of the fitted model or the at least one object motion parameter.

15. A method, comprising:
determining deformation vector fields for a 4D image set, which includes three or more images corresponding to three or more different motion phases of motion of a moving object;
generating a volume curve for a voxel based on the deformation vector fields;
fitting a predetermined motion model to the volume curve; and
estimating at least one object motion parameter based on the fitted model and generating a signal indicative thereof.

16. The method of claim 15, wherein determining the deformation vector fields includes employing a non-rigid registration that maps a phase of an image corresponding one of the three or more images to the different phases of the other images of the three or more images, thereby determining a voxel-wise correspondence on the motion cycle, and minimizing an objective function that includes a weighted similarity term and a regularizing term.

17. The method of claim 15, wherein the volume curve describes a volume change over the motion cycle as a function of time and determining the volume curve includes calculating one or a Jacobian matrix consisting of first derivatives of the deformation vector fields or calculating intensity differences of the deformation vector fields.

18. The method of claim 15, wherein the predetermined motion model is a curve represented by a cos²ⁿ function, wherein n corresponds to a phase of interest.

19. The method of claim 15, wherein the at least one object motion parameter includes at least one of a motion amplitude, a motion phase, a motion offset, or a time of a predetermined motion phase.

20. The method of claim 19, further comprising:
determining a confidence level of the estimate of the at least one object motion parameter based on an error difference between the fitted model and the volume curve.

21. The method of claim 20, wherein the confidence level is determined based on a squared difference between the fitted model and the volume curve, weighted with an inverse of an amplitude of the motion cycle.

22. The method of claim 15, further comprising:
identifying a state of the object by comparing one or more of the fitted model or the at least one object motion parameter based on a bank of patterns and/or values corresponding to known healthy and unhealthy states.

23. The method of claim 22, further comprising:
recommending a course of action for the object based on the determined state of the object.

24. The method of claim 15, further comprising:
displaying at least one of the fitted model or the at least one object motion parameter.

25. A computer readable storage medium encoded with computer readable instructions, which, when executed by a processor, cause the processor to: determine at least one of a motion cycle amplitude or phase based at least three images corresponding to different motion phases and on a voxel-wise correspondence on the motion cycle.
